(19) United States
(12) Patent Application Publication
(10) Pub. No.: US 2014/0295158 A1
(43) Pub. Date: Oct. 2, 2014

(54) WINDOW FOR DISPLAY DEVICE AND DISPLAY DEVICE INCLUDING THE WINDOW

(71) Applicant: Samsung Display Co., Ltd., Gyeonggi-Do (KR)

(72) Inventors: Ju-Suk OH, Yongin-City (KR); Yuki HONGO, Yongin-City (KR); Kwan-Young HAN, Yongin-City (KR); Hun-Kyo KIM, Yongin-City (KR)

(73) Assignee: Samsung Display Co., Ltd., Gyeonggi-Do (KR)

(21) Appl. No.: 14/152,395

(22) Filed: Jan. 10, 2014

(30) Foreign Application Priority Data
Mar. 27, 2013 (KR) 10-2013-0033066

(51) Int. Cl. B32B 27/08

(52) U.S. Cl. CPC B32B 27/08
USPC 428/216; 428/213; 428/215

(57) ABSTRACT

A window for a display device includes a polymer resin layer including a polymer resin having tensile elongation at break point of greater than or equal to about 20% and a melt flow rate (MFR) of greater than or equal to about 30 g/10 minutes (at 300° C.), and a light transmittance film positioned on at least one side of the polymer resin layer. The polymer resin layer has a thickness of about 30% or more, based on a total thickness of the polymer resin layer and the light transmittance film. A display device includes the window.

### CROSS-REFERENCE TO RELATED APPLICATION

Korean Patent Application No. 10-2013-0033066, filed on Mar. 27, 2013, in the Korean Intellectual Property Office, and entitled: “Window For Display Device and Display Device Including the Window,” is incorporated by reference herein in its entirety.

### BACKGROUND

1. Field

Embodiments are directed to a window for a display device and a display device including the same.

2. Description of the Related Art

Currently known display devices include a liquid crystal display (LCD), a plasma display panel (PDP), an organic light emitting diode (OLED) device, a field effect display (FED), an electrophoretic display device, and the like.

### SUMMARY

Embodiments are directed to a window for a display device including a polymer resin layer including a polymer resin having tensile elongation at break point of greater than or equal to about 20% and a melt flow rate of greater than or equal to about 30 g/10 minutes at 300° C., and a light transmittance film positioned on at least one side of the polymer resin layer. The polymer resin layer has a thickness of about 30% or more, based on a total thickness of the polymer resin layer and the light transmittance film.

The polymer resin may include a polycarbonate, a polycarbonate-polymethylmethacrylate blend, a cycloolefin polymer, a copolymer thereof, or a combination thereof.

The polymer resin may have a tensile elongation at break point of about 20 to about 200%.

The polymer resin may have a tensile elongation at break point of about 60 to about 90%.

The polymer resin may have a melt flow rate of about 30 g/10 minutes to about 80 g/10 minutes at 300° C.

The thickness of the polymer resin layer may be about 30 to about 80% based on a total thickness of the polymer resin layer and the light transmittance film.

The polymer resin layer may have a thickness of about 300 μm to about 800 μm.

The light transmittance film may include a plastic substrate selected from a polyethyleneterephthalate film, a polycarbonate film, a polymethylmethacrylate film, a polycarbonate/polymethylmethacrylate film, or a combination thereof.

The light transmittance film may further include a binder layer positioned between the polymer resin layer and the plastic substrate.

The plastic substrate may have a thickness of about 50 μm to about 100 m. The binder layer may have a thickness of about 5 μm to about 10 μm.

The light transmittance film further may further include a hard coating layer positioned on one side of the plastic substrate.

The hard coating layer may include an organic material, an inorganic material, or an organic/inorganic composite material.

The hard coating layer may have a thickness of about 75 μm to about 150 μm.

The light transmittance film may include an in-mold decoration film.

The window may have impact resistance of at least about 20 cm by a ball drop measurement device using 130 g ball drop.

The window may have surface hardness of about 6 H to about 8 H.

The window may have a thickness of less than or equal to about 1 mm.

The window may be obtained by injection-molding of the light transmittance film and the polymer resin in a film insert manner.

A display device may include the window for a display device.

### BRIEF DESCRIPTION OF THE DRAWING

Features will become apparent to those of skill in the art by describing in detail exemplary embodiments with reference to the attached drawings in which:

FIG. 1 illustrates a cross-sectional view depicting a window for a display device according to an embodiment.

FIG. 2 illustrates a top view of a display device having the window for a display device according to an embodiment

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figure, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

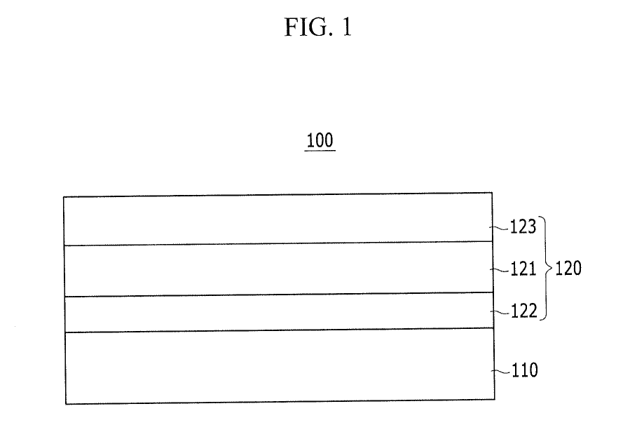

Referring to FIG. 1, a window for a display device according to one embodiment will be described.

FIG. 1 illustrates a cross-sectional view depicting a window for a display device according to an embodiment.

According to the embodiment, a window 100 for a display device may include a polymer resin layer 110 and a light transmittance film 120 positioned on one side of the polymer resin layer 110.

The polymer resin layer 110 may be made of an injection moldable polymer resin. The polymer resin may be selected from resins having a tensile elongation at break point of greater than or equal to about 20% and a melt flow rate (MFR) of greater than or equal to about 30 g/10 minutes (at 300° C.).

The term “tensile elongation at break point” refers to an elongation rate when a polymer resin is elongated at a predetermined speed until broken. The polymer resin having a tensile elongation at break point within the disclosed range may secure impact resistance of a window for a display device. The polymer resin may have about 20% to about 200% tensile elongation at break point within the range.

The term “melt flow rate” refers to flow easiness of a polymer resin in a molten state at 300° C. for 10 minutes. When the polymer resin has a melt flow rate within the disclosed range, crystallinity is not excessively formed in the polymer resin during the injection-molding, excellent light transmittance and simultaneously high workability may be secured, and accordingly, a window for a display device having no curl or waving but having a good appearance may be manufactured. The polymer resin may have a melt flow rate ranging from about 30 g/10 minutes to about 80 g/10 minutes within the range.

When the polymer resin has a tensile elongation at break point and melt flow rate within the ranges, impact resistance and surface hardness characteristics and good appearance of a window for a display device may be secured.

The polymer resin having a tensile elongation at break point and a melt flow rate may include, for example polycarbonate (PC), a polycarbonate-polymethylmethacrylate (PC-PMMA) blend, a cycloolefin polymer (COP), a copolymer thereof, or a combination thereof. Herein, the ‘combination’ may refer to a blend or a stack of two or more layers.

The light transmittance film 120 may include a plastic substrate 121, a binder layer 122, and a hard coating layer 123.

The plastic substrate 121 may be a substrate used for a film insert forming process. For example, the plastic substrate 121 may be a polyethyleneterephthalate (PET) film, a polycarbonate (PC) film, a polymethylmethacrylate (PMMA) film, a polycarbonate/polymethylmethacrylate (PC/PMMA) film, or a combination thereof. The plastic substrate 121 may have, for example a thickness of about 50 μm to about 100 μm.

The binder layer 122 may be positioned between the polymer resin layer 110 and the plastic substrate 121 and may provide bonding therebetween. The binder layer 122 may include, for example an acryl-based binder. The binder layer 122 may have, for example a thickness of about 5 μm to about 10 μm.

The hard coating layer 123 may be positioned at a surface of the window 100 for a display device and thus may improve the surface hardness. The hard coating layer 123 may include, for example, an organic material, an inorganic material, or an organic/inorganic composite material. The organic material may include, for example, an acryl-based compound, an epoxy-based compound, or a combination thereof. The inorganic material may include, for example, silica, alumina, or a combination thereof. The organic/inorganic composite material may include, for example polysilsesquioxane. The hard coating layer 123 may be a monolayer or a plural layer, and may have a thickness of, for example, about 50 μm to about 150 m.

At least one of the binder layer 122 and hard coating layer 123 may be omitted.

The light transmittance film 120 may be, for example an IMD film (in mold decoration film).

The light transmittance film 120 may be formed on one side of the polymer resin layer 110. In other implementations, the light transmittance film 120 may be formed on both sides of the polymer resin layer 110.

The window 100 for a display device may be obtained by injection-molding the light transmittance film 120 and the polymer resin in a film insert manner.

The polymer resin layer 110 may have a thickness of about 30% or more, based on a total thickness of the window 100 for a display device, for example, based on a total thickness of the polymer resin layer 110 and the light transmittance film 120. For example, when the polymer resin layer 110 and the light transmittance film 120 have a total thickness of less than or equal to about 1 mm, the polymer resin layer 110 may have a thickness of greater than or equal to about 0.3 mm. When the polymer resin layer 110 has a thickness within the disclosed range, a sufficient space for a polymer resin to flows in during the injection-molding in a film insert manner may be secured. Accordingly, not only may impact resistance and surface hardness characteristics of the aforementioned polymer resin be secured, but also, an excellent appearance of a window for a display device may be obtained. The window 100 for a display device may have a thickness of less than or equal to about 1 mm, and the polymer resin layer 110 may have a thickness of about 300 μm to about 800 μm.

The window 100 for a display device may satisfy impact resistance and surface hardness characteristics simultaneously, as described above. For example, the window 100 for a display device may have an impact resistance of at least 20 cm, with reference to dropping a load of 130 g using a Ball drop measurement device, and simultaneously, the window 100 may have a surface hardness ranging from about 6 H to 8 H, with a reference to applying a load of 1 kg with a pencil hardness tester (BMS Tech).

The above-explained window 100 for a display device may be used for various display devices. The display device may be a liquid crystal display (LCD), an organic light emitting diode (OLED) device, a plasma display, a field effect display (FED) device, an electrophoresis display device, and the like, as examples.

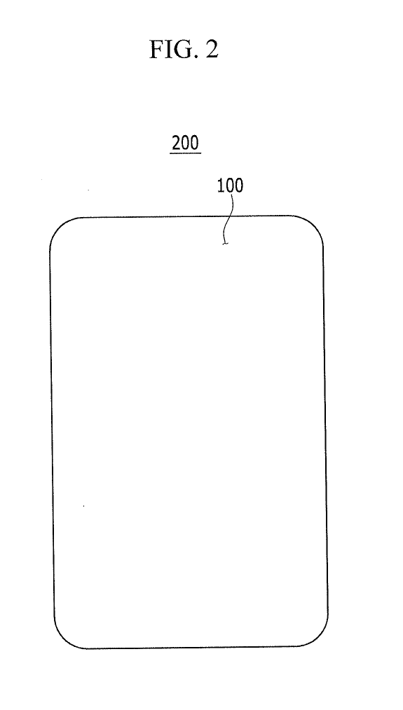

FIG. 2 illustrates a top view of a display device 200 having a window for a display device 100 disposed thereon according to an embodiment. The display module 200 may be a liquid crystal display module, an organic light emitting diode module, a plasma display module, a field effect display module, an electrophoresis display module, and the like.

Hereinafter, the present disclosure is illustrated in more detail with reference to examples.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

Manufacture of Window for Display Device

### EXAMPLE 1

A polysilsesquioxane solution was coated onto one side of a PET film (PET100A4300, TOYOBO Co., Ltd.), a non-adhesive PET film (PET100A4100) was covered thereon, and the resultant was UV-cured with 4000 mJ/cm² to 4500 mJ/cm² in a UV chamber filled with nitrogen gas (N₂). Next, the PET film was put into an injection molder, and a 0.5 mm-thick polymethylmethacrylate (PC-PMMA) resin layer was formed thereon by injection-molding a polycarbonate-polymethylmethacrylate (PC-PMMA) blend resin (MB6001UR, Mitsubishi Engineering Plastics Co.) having the characteristics in the following Table 1, thereby manufacturing a 0.7 mm-thick window for a display device.

TABLE 1

| | Weight average | | |
|---|---|---|---|
| | molecular weight | Tensile elongation at | Melt flow |
| | (Mw) | break point (%) | rate |
| PC-PMMA | 25,000 | 80 | 49 |
| blend resin | | | |

Herein, the tensile elongation at break point in Table was measured by an ASTM D-638 method, and the melt flow rate was measured by an ASTM D1238 method.

### EXAMPLE 2

A 0.7 mm-thick window for a display device was manufactured according to the same method as Example 1, except for using a cycloolefin polymer (COP) resin having the characteristics in the following Table 2, to form a 0.5 mm-thick cycloolefin polymer (COP) resin layer instead of the polycarbonate-polymethylmethacrylate (PC-PMMA) blend resin.

TABLE 2

| | Weight average | Tensile elongation at | Melt flow |
|---|---|---|---|
| | molecular weight | break point (%) | rate |
| COP resin | 45,000 | 60 | 60 |

### EXAMPLE 3

A 0.7 mm-thick window for a display device was manufactured according to the same method as Example 1, except for using a polycarbonate (PC) resin having the characteristics in the following Table 3, to form a 0.5 mm-thik polycarbonate (PC) resin layer instead of the polycarbonate-polymethylmethacrylate (PC-PMMA) blend resin.

TABLE 3

| | Weight average | Tensile elongation at | Melt flow |
|---|---|---|---|
| | molecular weight | break point (%) | rate |
| PC resin | 20,313 | 90 | 55 |

### EXAMPLE 4

A 1 mm-thick window for a display device including a 0.8 mm-thick polymethylmethacrylate (PC-PMMA) resin layer was manufactured according to the same method as Example 1.

TABLE 4

| | Weight average | Tensile elongation at | Melt flow |
|---|---|---|---|
| | molecular weight | break point (%) | rate |
| PC-PMMA resin | 25,000 | 80 | 49 |

### COMPARATIVE EXAMPLE 1

A 0.7 mm-thick window for a display device was manufactured according to the same method as Example 1, except for using a polymethylmethacrylate (PMMA) resin having the characteristics in the following Table 5, to form a 0.5 mm-thick polymethylmethacrylate (PMMA) resin layer instead of the polycarbonate-polymethylmethacrylate (PC-PMMA) blend resin.

TABLE 5

| | Weight average | Tensile elongation at | Melt flow |
|---|---|---|---|
| | molecular weight | break point (%) | rate |
| PMMA resin | 40,274 | 2-10 | 38 |

### COMPARATIVE EXAMPLE 2

A 0.7 mm-thick window for a display device was manufactured according to the same method as Example 1, except for using a polycarbonate (PC) resin having the characteristics in the following Table 6, to form a 0.5 mm-thick polycarbonate (PC) resin layer instead of the polycarbonate-polymethylmethacrylate (PC-PMMA) blend.

TABLE 6

| | Weight average | Tensile elongation at | Melt flow |
|---|---|---|---|
| | molecular weight | break point (%) | rate |
| PC | 35,000 | 90 | 20 |

### COMPARATIVE EXAMPLE 3

A 1 mm-thick window for a display device was manufactured according to the same method as Example 1, except for using a 0.2 mm-thick polycarbonate-polymethylmethacrylate (PC-PMMA) resin layer instead of the 0.5 mm-thick polymethylmethacrylate (PC-PMMA) resin layer.

Evaluation

The windows for a display device according to Examples 1 to 4 and Comparative Examples 1 to 3 were evaluated regarding impact resistance, surface hardness, and appearance.

The impact resistance was evaluated by measuring a maximum height for which the windows for a display device had no crack when a metal weight having a load of 130 g was dropped in the center of the windows for a display device using a Ball Drop measuring device.

The surface hardness was measured applying a load of 1 kg with a pencil hardness tester (BMS Tech).

The appearance was evaluated by examining with naked eyes whether the windows for a display device were curled or wavy.

The results are provided in Table 7.

TABLE 7

| | Impact | Surface | |
|---|---|---|---|
| | resistance | hardness | Appearance |
| Example 1 | 80 cm | 8H | OK |
| Example 2 | 90 cm | 8H | OK |
| Example 3 | 100 cm | 8H | OK |
| Example 4 | 80 cm | 8H | OK |
| Comparative Example 1 | 10 cm | 4H | OK |
| Comparative Example 2 | 100 cm | 8H | curl |
| Comparative Example 3 | 10 cm | 4H | wavy |

Referring to Table 7, the windows for a display device according to Examples 1 to 4 were identified to have high impact resistance and surface hardness and excellent appearance. On the other hand, the window for a display device using a polymer resin having a low tensile elongation at break point according to Comparative Example 1 had low impact resistance and surface hardness, the window a display device using a polymer resin having a low melt flow rate according to Comparative Example 2 had deformed appearance, and the window for a display device using a thin polymer resin layer according to Comparative Example 3 had insufficient surface hardness, melt flow rate, and appearance. Based on the results, when a polymer resin had tensile elongation at break point, a melt flow rate, and a thickness within a predetermined range, impact resistance, hardness, and appearance of a window for a display device were all satisfactory.

By way of summation and review, a display device may include a display module displaying an image and a window protecting the display module. The window may be made of glass. However, the glass may be easily broken by an external impact. When an external impact is applied to a portable device such as a mobile phone, the window may be easily damaged.

On the other hand, when a display device has a touch screen function and a window made of a plastic material instead of the glass, a hand or a sharp tool such as a pen may frequently contact one side of the window. In this case, the window made of plastic may be easily scratched on the surface. In addition, the window made of plastic may be subject to appearance deformation such as curling or waviness.

In contrast, embodiments are directed to a window for a display device that prevents or reduces the likelihood appearance deformation while simultaneously improving impact resistance and surface hardness.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof as set forth in the following claims.

What is claimed is:

1. A window for a display device, the window comprising:
a polymer resin layer including a polymer resin having tensile elongation at break point of greater than or equal to about 20% and a melt flow rate of greater than or equal to about 30 g/10 minutes at 300° C.; and
a light transmittance film positioned on at least one side of the polymer resin layer,
wherein the polymer resin layer has a thickness of about 30% or more, based on a total thickness of the polymer resin layer and the light transmittance film.

2. The window for a display device as claimed in claim 1, wherein the polymer resin includes a polycarbonate, a polycarbonate-polymethylmethacrylate blend, a cycloolefin polymer, a copolymer thereof, or a combination thereof.

3. The window for a display device as claimed in claim 1, wherein the polymer resin has a tensile elongation at break point of about 20 to about 200%.

4. The window for a display device as claimed in claim 3, wherein the polymer resin has a tensile elongation at break point of about 60 to about 90%.

5. The window for a display device as claimed in claim 1, wherein the polymer resin has a melt flow rate of about 30 g/10 minutes to about 80 g/10 minutes at 300° C.

6. The window for a display device as claimed in claim 1, wherein the thickness of the polymer resin layer is about 30 to about 80% based on a total thickness of the polymer resin layer and the light transmittance film.

7. The window for a display device as claimed in claim 1, wherein the polymer resin layer has a thickness of about 300 μm to about 800 μm.

8. The window for a display device as claimed in claim 1, wherein the light transmittance film includes a plastic substrate selected from a polyethyleneterephthalate film, a polycarbonate film, a polymethylmethacrylate film, a polycarbonate/polymethylmethacrylate film, or a combination thereof.

9. The window for a display device as claimed in claim 8, wherein the light transmittance film further includes a binder layer positioned between the polymer resin layer and the plastic substrate.

10. The window for a display device as claimed in claim 9, wherein:
the plastic substrate has a thickness of about 50 μm to about 100 μm, and
the binder layer has a thickness of about 5 μm to about 10 μm.

11. The window for a display device as claimed in claim 8, wherein the light transmittance film further includes a hard coating layer positioned on one side of the plastic substrate.

12. The window for a display device as claimed in claim 11, wherein the hard coating layer includes an organic material, an inorganic material, or an organic/inorganic composite material.

13. The window for a display device as claimed in claim 11, wherein the hard coating layer has a thickness of about 75 μm to about 150 μm.

14. The window for a display device as claimed in claim 1, wherein the light transmittance film includes an in-mold decoration film.

15. The window for a display device as claimed in claim 1, wherein the window has impact resistance of at least about 20 cm by a ball drop measurement device using 130 g ball drop.

16. The window for a display device as claimed in claim 1, wherein the window has surface hardness of about 6 H to about 8 H.

17. The window for a display device as claimed in claim 1, wherein the window has a thickness of less than or equal to about 1 mm.

18. The window for a display device as claimed in claim 1, wherein the window is obtained by injection-molding of the light transmittance film and the polymer resin in a film insert manner.

19. A display device comprising the window for a display device as claimed in claim 1.
